(19) United States
(12) Patent Application Publication
(10) Pub. No.: US 2005/0213969 A1
(43) Pub. Date: Sep. 29, 2005

(54) Light transmission apparatus

(75) Inventor: Katsuhiko Hakomori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/965,767

(22) Filed: Oct. 18, 2004

(30) Foreign Application Priority Data
Mar. 26, 2004 (JP) 2004-092470

(51) Int. Cl. H04B 10/08

(52) U.S. Cl. 398/33

(57) ABSTRACT

In a light transmission apparatus which controls an optical excitation intensity of an amplifying optical fiber or an attenuation of an optical variable attenuator based on an output light intensity, the output light intensity is sampled. When a change rate of an input light intensity exceeds a threshold value, the optical excitation intensity or the attenuation is controlled based on the output light intensity immediately before the change rate exceeds the threshold value. Accordingly, an occurrence of an optical surge is prevented and it is made possible to output an optical signal free from a signal error or a signal disconnected state.

### BACKGROUND OF THE INVENTION

1. Field of the Invention

The present invention relates to a light transmission apparatus, and in particular to a light transmission apparatus which controls an optical output to be maintained at a fixed value by using an amplifying optical fiber or an optical variable attenuator.

2. Description of the Related Art

With the Internet being rapidly spread, demands for enabling a digital signal transmission to be longer in distance and larger in capacity have been enhanced. It has been generally recognized that an optical fiber transmission system will continue to widely spread in order to realize a broadband service, an ADSL service, and the like, by using an amplifying optical fiber and an optical variable attenuator respectively performing a loss compensation and an optical level control on an optical fiber.

On the other hand, with respect to a light transmission apparatus used in such an optical fiber transmission system, the output light level is extremely high, so that a direct view of an optical output or an exposure thereto would be harmful to a human body. Therefore, handling standards are defined by the International Electrotechnical Commission (IEC60825-1) and the like.

Also, in addition to the human body, when an excessively powerful output light (optical surge) is generated by a transitional state due to an operation sequence of the light transmission apparatus, a damage of a device such as a photodiode within an optical receiver connected to the output side of the light transmission apparatus is conceivable. Therefore, it is required to control the optical output to be maintained at a fixed value under any conditions in order to prevent such an optical surge from being generated.

FIG. 7 shows an example [1] of a prior art light transmission apparatus which controls the optical output to be maintained at a fixed value. This example shows a light transmission apparatus which is provided with an amplifying optical fiber and a control loop for controlling the optical output to be maintained at a fixed value by a feedback, and which interrupts an excitation light of the amplifying optical fiber when the optical input level is equal to or less than a threshold value. As shown, an optical input is passed through an optical coupler 1, transmitted to an amplifying optical fiber 2 such as an erbium doped fiber (EDF) to be directly and optically amplified, and then passed through an optical coupler 3 to provide an optical output. This optical output is subject to a feedback control (optical output fixing control) by a control loop CL, so as to be controlled to maintain a fixed value.

This control loop CL is composed of a photodiode 4 for inputting a branched light from the optical coupler 3 to be converted into an electric signal, an output monitor circuit 5 for converting the electric signal (electric current) outputted from the photodiode 4 into a corresponding voltage, an error amplifier 6 for comparing the output voltage from the output monitor circuit 5 with a reference voltage Vref and outputting an error between the two voltages, an LD drive circuit 7 for generating an LD drive voltage according to an output voltage from the error amplifier 6, and an excitation laser diode (LD) 8 for receiving the LD drive voltage from the LD drive circuit 7 to excite or pump the amplifying optical fiber 2.

Namely, when the optical input level fluctuates, the optical output signal is converted into the corresponding electric signal and the error amplifier 6 drives the excitation laser diode 8 through the LD drive circuit 7 so as to coincide the voltage of the electric signal with the reference voltage Vref, thereby performing the feedback control for exciting the amplifying optical fiber 2 and the optical output fixing control for maintaining the optical output at a fixed value.

It is to be noted that on the input side the branched light from the optical coupler 1 is provided to the photodiode 9, and a current signal outputted from the photodiode 9 is converted into a corresponding voltage signal by the input monitor circuit 10. When this voltage value is equal to or less than a threshold value (not shown), the input monitor circuit 10 controls the LD drive circuit 7 to interrupt the operation of the control loop CL so as to suspend the optical output fixing control. Such an arrangement prevents the excitation light of the excitation laser diode 8 from being provided to the amplifying optical fiber 2.

FIG. 8 shows an example [2] of a prior art light transmission apparatus which controls the optical output to be maintained at a fixed value. The difference between this example [2] and above-mentioned example [1] is that an optical variable attenuator 11 is substituted for the amplifying optical fiber 2 and an optical variable attenuator drive circuit 12 is substituted for the LD drive circuit 7 and the excitation laser diode 8 for controlling the optical variable attenuator 11.

In this example [2], when the optical input level fluctuates, the optical variable attenuator drive circuit 12 controls according to the output of the error amplifier 6 so as to vary the attenuation of the optical variable attenuator 11 according to the input level, so that the optical output is maintained at a fixed value.

It is to be noted that on the input side the branched light from the optical coupler 1 is provided to the photodiode 9, and the current signal outputted from the photodiode 9 is converted into the corresponding voltage signal by the input circuit monitoring portion 10. When the voltage value at this time is equal to or less than a threshold value (not shown), the input monitor circuit 10 controls the optical variable attenuator drive circuit 12 to interrupt the operation of the control loop CL. Such an arrangement maintains the attenuation of the optical variable attenuator 11 at a fixed amount and suspends the optical output fixing control.

Problems of such examples [1] and [2] will now be described referring to FIGS. 9A-9C and FIGS. 10A-10C showing their operational waveform diagrams respectively.

Firstly, referring to FIGS. 9A-9C showing the operational waveform diagrams of the example [1], a case of an optical input fluctuation as shown in FIG. 9A will be described, where the optical input level decreases at a waveform portion “a”, becomes equal to or less than a threshold value for suspending the output fixing control, becomes minimum at a waveform portion “b”, and then increases at a waveform portion “c”.

In the light transmission apparatus shown in FIG. 7, the optical input is passed through the amplifying optical fiber 2 to the optical coupler 3, and further provided to the error amplifier 6 through the photodiode 4 and the output monitor circuit 5. The error amplifier 6 compares the optical input with the reference voltage Vref and transmits the error between the two voltages to the LD drive circuit 7, which generates an excitation light as shown in FIG. 9B corresponding to the output voltage of the error amplifier 6, thereby performing a loss compensation of the optical input decreasing portion “a” shown in FIG. 9A.

When the optical input drop shown in FIG. 9A occurs, a problem arises when the output of the excitation LD 8 is once interrupted by the input monitor circuit 10 as shown in FIG. 9B and the optical input turns to an increase. Namely, in the optical input increasing portion “c” shown in FIG. 9A, since the excited optical energy still remains in the amplifying optical fiber 2 and is superimposed with the optical energy being recovered according to the optical input increasing portion “c”, an optical surge portion “e” having an optical output level sharply increased from a steady level “d” appears as shown in FIG. 9C.

Thereafter, the optical output decreases with the energy emission of the amplifying optical fiber 2 as shown by the waveform portion “f”, and stabilizes at the stable level “d” in a time “g”=50 ms as shown in FIG. 9C.

Also, with regard to FIGS. 10A-10C showing operational waveform diagrams of the example [2], the optical input level decreases at the waveform portion “a” in FIG. 10A similar to FIG. 9A, becomes equal to or less than a threshold value for suspending the optical output fixing control, becomes minimum at the waveform portion “b”, and then increases at the waveform portion “c”. When such an optical input fluctuation occurs, the attenuation of the optical variable attenuator 11 has a time lag for the attenuation control operation as shown in FIG. 10B. Accordingly, the optical output generates the optical excessive output waveform portion “e” rising sharply from the stable optical level “d”, and stabilizes in a time “f”=several 100 ms.

In a different prior art light transmission apparatus having an object of preventing the occurrence of the above-mentioned optical surge or reducing the surge amount, an optical ALC (automatic level control) loop is provided with an optical input monitor for monitoring an optical input power from a light branched from an input light to generate a signal, an input change detector for conducting a predetermined calculation for the input signal from the optical input monitor to generate a signal detecting the change of the optical input power, a comparator for comparing the detection signal with a preset level, and a switching unit for switching the level of a reference voltage in response to an output signal of the comparator, and at the time of changing the optical input power, a reference voltage at the time of changing the input is generated instead of the reference voltage at the time of the normal operation; and an optical amplifier is ALC-controlled according to the reference voltage to forcibly lower the current of an exciting LD at the time of changing the input, thereby reducing a surge amount output at the time of rising the input light (see e.g. patent document 1).

Also, in a further different prior art light transmission apparatus, an optical amplifier is provided with an input fluctuation detection circuit for outputting a signal according to an optical input signal fluctuation, and an automatic level controller for controlling an excitation light so as to fix an optical output signal level based on a monitor signal from an optical output monitor circuit; the automatic level controller is provided with loop gain controlling means for controlling a loop gain of an automatic level control; and the loop gain controlling means change the loop gain of the automatic level controller by the signal from the input fluctuation detection circuit (see e.g. patent document 2).

Furthermore, in a yet further different prior art light transmission apparatus, a part of an input light to an optical amplifier is received by a circuit of a light receiving device. As for a converted electric signal, a modulation signal through a low-pass filter and a maximum value of values averaged by eliminating an influence of an abnormal peak of a previous step are held in a peak hold circuit. A control switch offset value in which a signal fluctuation part is considered for this value is added in an addition circuit and this value is set as the control switch value of the optical amplifier. When a signal optical input value becomes lower than this value, this is detected by a comparator, a switch signal is added to a switch and the gain of the optical amplifier is lowered by switching the control of an exciting light source drive circuit from an output constant control circuit to a low gain setting. As a result, an abnormal peak output is suppressed (see e.g. patent document 3).
[Patent document 1] Japanese patent application laid-open No. 9-331095
[Patent document 2] Japanese patent application laid-open No. 10-209970
[Patent document 3] Japanese patent application laid-open No. 7-307704

In case of the patent document 1, occurrence of the optical surge is prevented by fixing the optical output at a low level after detecting the fluctuation of the input light. Therefore, the output level cannot be compensated because the output at the time of the input light fluctuation is fixed at the reference voltage. This may risk an occurrence of an optical signal error and a signal disconnection.

Also, in case of the patent document 2, since the system reduces the surge by reducing a loop gain of the error amplifying circuit of the feedback control after detecting the fluctuation of the input light, the input light level is extremely reduced by the output light level error if the input light level is low, thereby risking an occurrence of an optical signal error and a signal disconnection, as in the above-mentioned patent document 1.

Also, in case of the patent document 3, since the basic arrangement is the same as that of the above-mentioned patent document 2, but reducing the gain by switching upon an input fluctuation, there is a risk of an occurrence of an optical signal error and a signal disconnection.

On the other hand, in such a light transmission apparatus, an eye pattern assumes a wide eye aperture “a” as shown in FIG. 11A when the signal bit rate is low while it assumes a narrow eye aperture “b” (b<a) as shown in FIG. 11B when the bit rate becomes high, so that the signal error easily occurs.

FIG. 11C shows the relationship between such a bit rate change and the allowable range of the signal error due to input waveform fluctuation. A solid line waveform “c” shows the lower limit range free from signal error at the time of low bit rate of FIG. 11A while a dotted line waveform “d” shows the lower limit range free from signal error at the time of high bit rate of FIG. 11B.

Namely, this shows that the allowable input fluctuation range free from the signal error is smaller at the time of the high bit rate than the low bit rate, so that as the bit rate increases the allowable input fluctuation range decreases as shown by an arrow in FIG. 11C. When the bit rate is high, as shown by the waveform “d”, measures against such a surge must be taken accordingly even if the input fluctuation is small.

### SUMMARY OF THE INVENTION

It is accordingly an object of the present invention to provide a light transmission apparatus which prevents an optical surge by controlling an optical amplifier or an optical attenuator preferably according to a bit rate even when an input level dynamically fluctuates, and makes an optical signal error-free so that signal disconnection is not caused.

In order to achieve the above-mentioned object, a light transmission apparatus according to the first invention comprises: an input light intensity monitoring portion which branches an input light and monitors an intensity of the input light; a change rate monitoring portion which monitors a change rate of the input light intensity; an excitation light source which outputs an excitation light; an optical amplifier which amplifies the input light with the excitation light; an output light intensity monitoring portion which branches an output light of the optical amplifier and monitors an intensity of the output light; and a sampling portion which periodically monitors the output light intensity monitored by the output light intensity monitoring portion; said apparatus has: a first control state in which the output light intensity is controlled by controlling the excitation light source based on an output of the output light intensity monitoring portion; and a second control state in which the excitation light source is controlled based on the output light intensity monitored by the sampling portion; and said apparatus operates in the second control state when the change rate monitored by the change rate monitoring portion exceeds a threshold value, based on the output light intensity monitored by the sampling portion immediately before the threshold value is exceeded.

A light transmission apparatus of the second invention is one according to the first invention, which further has a third control state in which the output of the excitation light source is suppressed when the input light intensity monitored by the input light intensity monitoring portion is equal to or less than a predetermined value.

A light transmission apparatus of the third invention comprises: an input light intensity monitoring portion which branches an input light and monitors an intensity of the input light; a change rate monitoring portion which monitors a change rate of the input light intensity; an optical attenuator which attenuates the input light; an output light intensity monitoring portion which branches an output light of the optical attenuator and monitors an intensity of the output light; and a sampling portion which periodically monitors the output light intensity monitored by the output light intensity monitoring portion; said apparatus has: a first control state in which the output light intensity is controlled by controlling the optical attenuator based on an output of the output light intensity monitoring portion; and a second control state in which the optical attenuator is controlled based on the output light intensity monitored by the sampling portion; and said apparatus operates in the second control state when the change rate monitored by the change rate monitoring portion exceeds a threshold value, based on the output light intensity monitored by the sampling portion immediately before the threshold value is exceeded.

A light transmission apparatus of the fourth invention is one according to the first to the third invention, wherein a transition is made from the second control state to the first control state after a lapse of time associated with a characteristic of the optical amplifier or the optical attenuator.

A light transmission apparatus of the fifth invention is one according to the first to the third invention, wherein the threshold value is set to be associated with a characteristic of the optical amplifier and a bit rate of the input light or the optical attenuator.

A light transmission apparatus according to the sixth invention comprises: a change rate monitoring portion which monitors a change rate of an input light intensity; an excitation light source which outputs an excitation light for excitation an optical amplifier; a sampling portion which periodically monitors an output light intensity of the optical amplifier; said apparatus has: a first control state in which the output light intensity is controlled by controlling the excitation light source based on the output light intensity of the optical amplifier; and a second control state in which the excitation light source is controlled based on the output light intensity monitored by the sampling portion; and said apparatus operates in the second control state when the change rate monitored by the change rate monitoring portion exceeds a threshold value, based on the output light intensity monitored by the sampling portion immediately before the threshold value is exceeded.

According to the light transmission apparatus of the present invention, occurrence of an optical surge can be prevented by operating in the second control state when the change rate of the input light intensity exceeds a threshold value, and a signal disconnection can be prevented by using the output light intensity immediately before the first control state monitored by the sampling portion, as a control reference for the excitation light source.

Also, since the light output intensity range free from signal disconnection varies according to the bit rate, by setting the threshold for the change rate of the input light intensity associated with the bit rate, the signal disconnection can be prevented while preventing the optical surge at the same time.

On the merits of the light transmission apparatus of the present invention, even if the input light fluctuates with a large change rate, the excitation light source can be controlled based on the optical output signal held by the sampling portion immediately before an optical input fluctuation, so that the occurrence of the optical surge is prevented and an optical signal free from a signal error and a signal disconnected state can be outputted.

### BRIEF DESCRIPTION OF THE DRAWINGS

The above and other objects and advantages of the invention will be apparent upon consideration of the following detailed description, taken in conjunction with the involving drawings, in which the reference numerals refer to like parts throughout and in which:

FIG. 1 is a block diagram showing an embodiment [1] of a light transmission apparatus according to the present invention;

FIGS. 2A-2E are operational waveform diagrams of the embodiment [1] shown in FIG. 1;

FIG. 3 is a block diagram showing an embodiment [2] of a light transmission apparatus according to the present invention;

FIGS. 4A-4E are operational waveform diagrams of the embodiment [2] shown in FIG. 3;

FIG. 5 is a circuit diagram showing an embodiment of a sample-and-hold circuit used in the embodiments of a light transmission apparatus according to the present invention;

FIGS. 6A-6D are operational time charts of the embodiment of the sample-and-hold circuit shown in FIG. 5;

FIG. 7 is a block diagram showing an example [1] of a prior art light transmission apparatus;

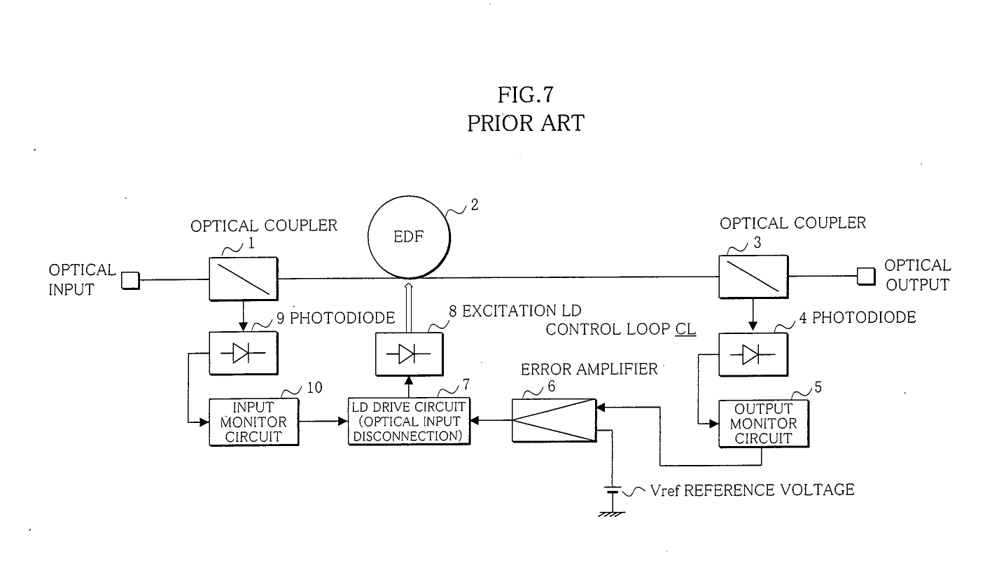

FIG. 8 is a block diagram showing an example [2] of a prior art light transmission apparatus;

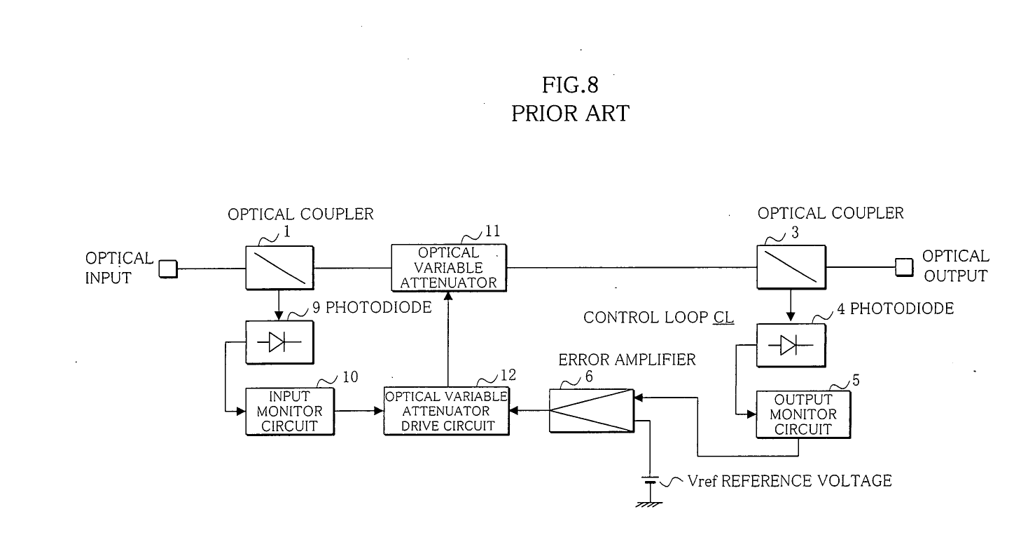

FIGS. 9A-9C are operational waveform diagrams of the example shown in FIG. 7;

FIGS. 10A-10C are operational waveform diagrams of the example [2] shown in FIG. 8; and

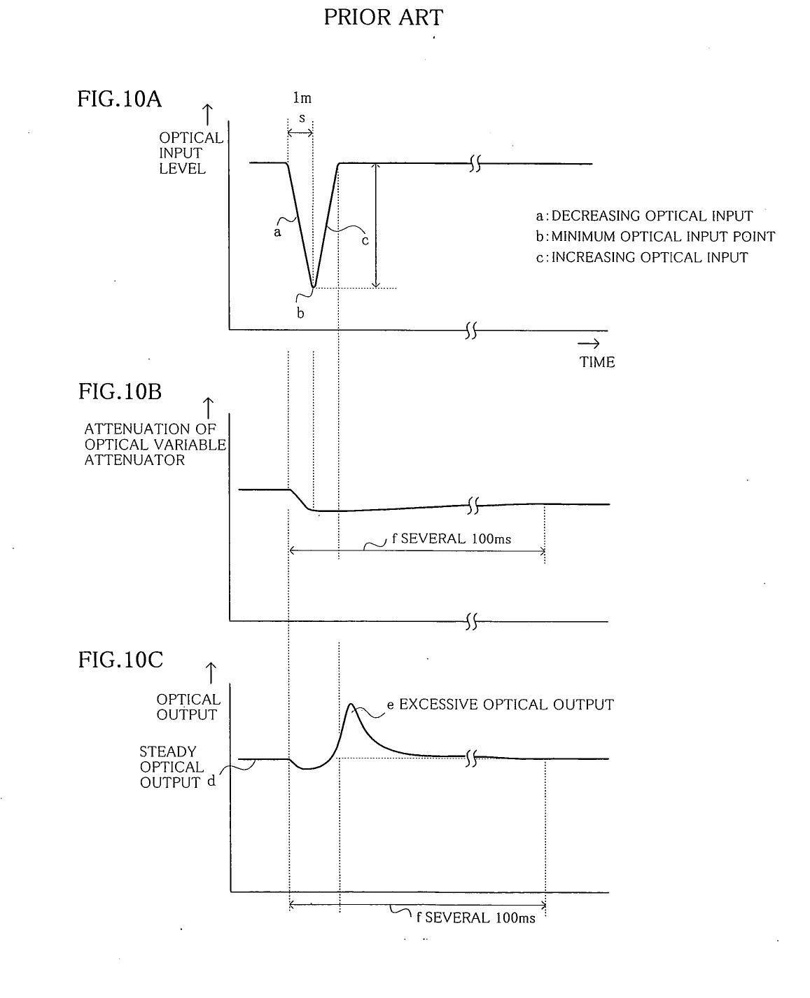

FIGS. 11A-11C are diagrams illustrating a relationship between a signal bit rate and an input fluctuation allowable range.

### DESCRIPTION OF THE EMBODIMENTS

### Embodiment [1]

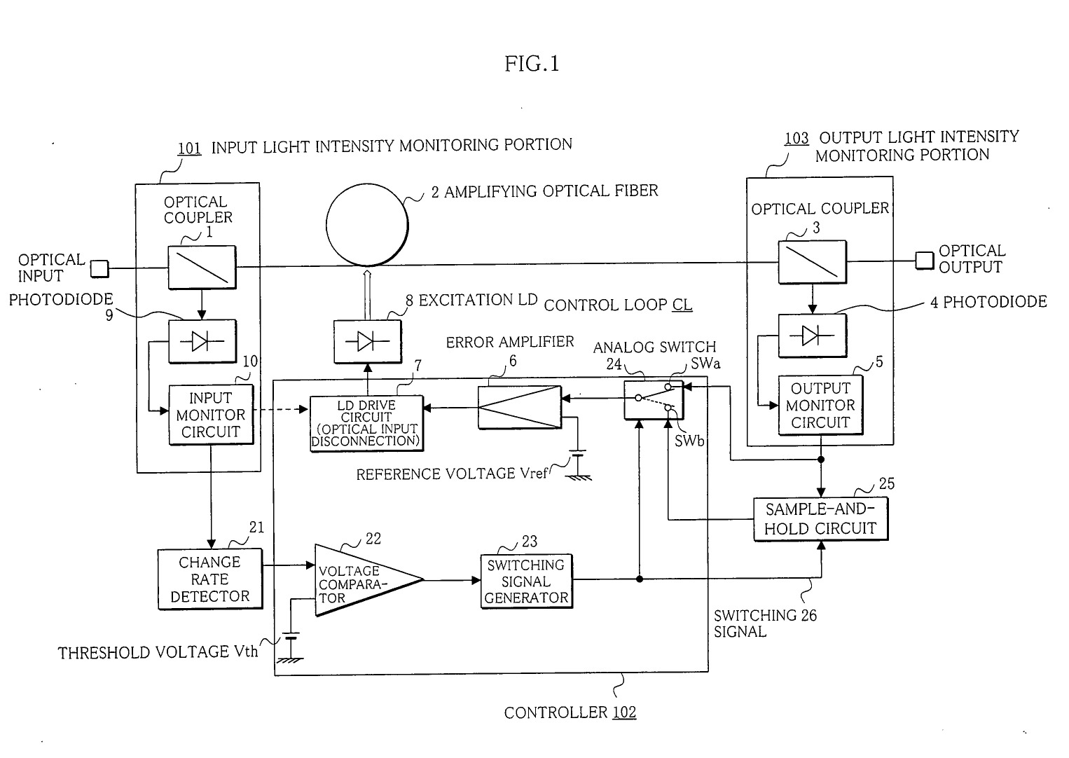

FIG. 1 shows an embodiment [1] of a light transmission apparatus according to the present invention. There are provided an input light intensity monitoring portion 101, a change rate detector 21 as a rate change monitoring portion, an excitation LD 8 as an excitation light source, an amplifying optical fiber 2 as an optical amplifier, an output light intensity monitoring portion 103, a sample-and-hold circuit 25 as a sampling portion, and a controller 102.

The input light intensity monitoring portion 101 is composed of an optical coupler 1, a photodiode 9, and an input monitor circuit 10. The controller 102 is composed of a voltage comparator 22, a switching signal generator 23, an analog switch 24, an error amplifier 6, and an LD drive circuit 7. The output light intensity monitoring portion 103 is composed of an optical coupler 3, a photodiode 4, and an output monitor circuit 5. The output monitor circuit 5 converts an electric signal (electric current) outputted from the photodiode 4 into a corresponding voltage.

The optical amplifier of the embodiment [1] is provided with a control loop CL which provides a feedback control for maintaining the optical output at a fixed value, as a method of controlling an excitation light source. Hereinafter, elements composing the control loop CL will be described.

An input light is inputted, through the optical coupler 1, to the amplifying optical fiber 2 of an erbium doped fiber (EBF) or the like. The amplifying optical fiber 2 is excited by an excitation light from the excitation LD 8, and amplifies the input light to be outputted. A part of an output light from the amplifying optical fiber 2 is branched by the optical coupler 3, monitored by the photodiode 4 and the output monitor circuit 5, and provided to the controller 102. The controller 102 controls an optical excitation intensity outputted from the excitation LD 8 based on the monitored optical output intensity of the amplifying optical fiber 2, thereby performing the optical feedback control (optical output fixing control).

The output of the output monitor circuit 5 is also provided to the sample-and-hold circuit 25. The sample-and-hold circuit 25 samples the output signal form the output monitor circuit 5 at a fixed interval to be held constantly. Upon receipt of the switching signal 26, the sample-and-hold circuit 25 holds the output signal from the output monitor circuit 5 at the generation time of the switching signal 26 while the switching signal 26 is generated.

In the controller 102, the error amplifier 6 compares the output voltage from the output monitor circuit 5 with a reference voltage Vref to output an error between the two voltages. The LD drive circuit 7 generates an LD drive voltage according to an output voltage of the error amplifier 6. The optical excitation intensity outputted from the excitation LD 8 is determined by the LD drive voltage from the LD drive circuit 7.

Also, in the controller 102, the analog switch 24 has one input terminal SWa to which the output monitor circuit 5 is connected and the other input terminal SWb to which an output of the sample-and-hold circuit 25 is connected, whereby a switching between both input terminals is performed based on the switching signal 26 outputted from the switching signal generator 23. The analog switch 24 selects the output from the sample-and-hold circuit 25 which is inputted from the input terminal SWb when the switching signal 26 is enabled by the switching signal generator 23. Also, when the switching signal 26 is disabled, the analog switch 24 selects the output from the output monitor circuit 5, that is the signal on the control loop CL which is inputted from the input terminal SWa.

The switching signal generator 23 is connected to the voltage comparator 22, which compares the voltage indicating a change rate outputted from the change rate detector 21 with a preset threshold voltage Vth, which may be a variable value set according to a signal bit rate as described later, and drives the switching signal generator 23 to generate the switching signal 26 when the change rate is equal to or more than the threshold voltage Vth, and does not send a drive signal to the switching signal generator 23 when the change rate is lower than the threshold voltage Vth. Also, the change rate detector 21 detects the change rate from the voltage corresponding to the optical input monitored by the input monitor circuit 5 to be provided to the voltage comparator 22.

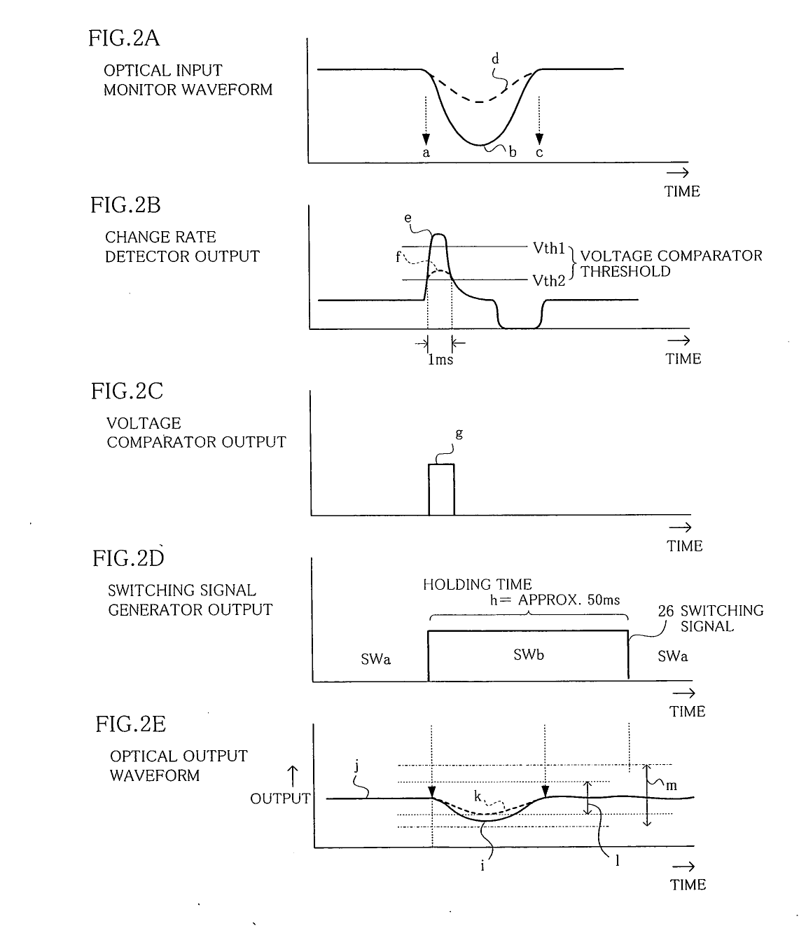

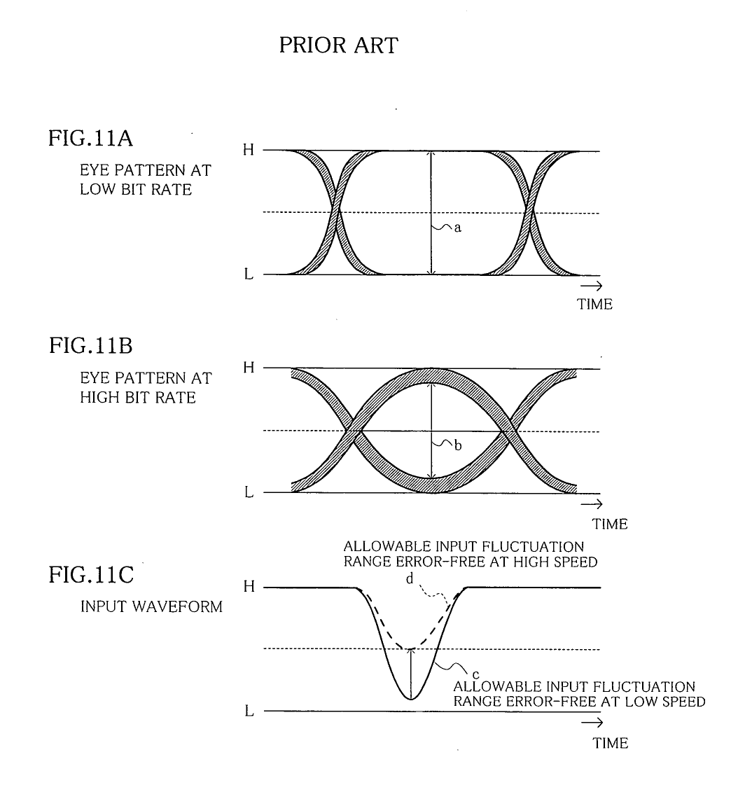

Operation of such an embodiment [1] will now be described referring to FIGS. 2A-2E. Firstly, waveforms shown by solid lines in FIGS. 2A, 2B, and 2E are examples of the low bit rate shown in FIG. 11A. It is to be noted that the threshold value of the voltage comparator 22 is set to Vth1 at this time.

When an optical input fluctuates or drops as shown by a waveform portion “b” of FIG. 2A, the change rate detector 21 detects the optical input decreasing at a time “a” and generates a differential waveform shown by a waveform portion “e” of FIG. 2B. Thereafter, since the optical input almost stabilizes around the bottom portion “b” and then starts to increase, the change rate detector 21 generates a differential waveform in the reverse direction while a portion thereof is cut as shown in FIG. 2B. At this time, when this differential waveform “e” exceeds the threshold voltage Vth1 in the voltage comparator 22, e.g. a pulse “g” having a pulse width of 1 ms is generated as shown in FIG. 2C.

The switching signal generator 23 having received the pulse “g” of FIG. 2C from the voltage comparator 22 generates the switching signal 26 as shown in FIG. 2D to be transmitted to the analog switch 24 and the sample-and-hold circuit 25.

A holding time of the switching signal 26 is approximately 50 ms corresponding to a time “h” shown in FIG. 2D. When the switching signal 26 is provided to the analog switch 24, the analog switch 24 switches from the terminal SWa (at a position shown by a solid line) to the terminal SWb (at a position shown by a dotted line), and selects the output signal of the sample-and-hold circuit 25 to be transmitted to the error amplifier 6.

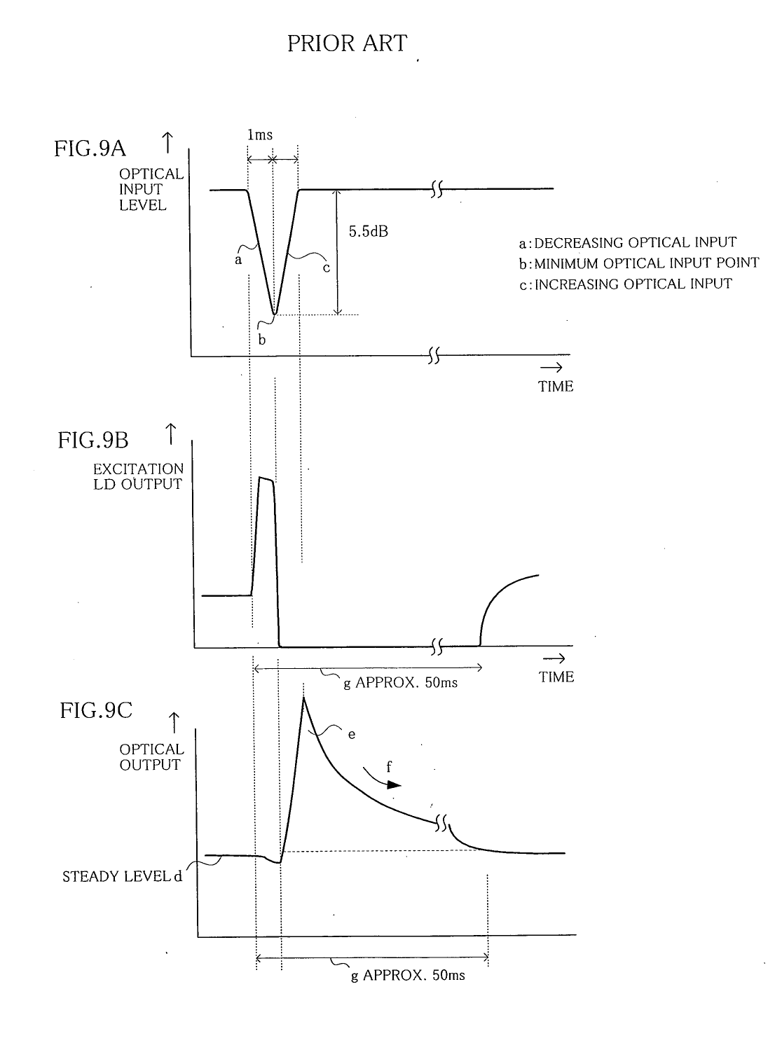

The above-mentioned holding time “h” of the switching signal 26 corresponds to the period for which the optical surge accompanying the optical input fluctuation is suppressed until the optical input restores the original input level. By focusing attention on a time relation of an optical surge occurrence and its disappearance in FIGS. 9A-9C, as the optical input level decreases and then increases as shown in FIG. 9A, the optical surge “e” included in the optical output gradually decreases as shown by the waveform portion “f” in FIG. 9C, where the time “g” before arriving at the stable level “d” depends on a characteristic of a stimulated emission of the amplifying optical fiber. This time “g” is a fixed time irrelevant to the bit rate, to which the holding time “h” shown in FIG. 2D corresponds.

The holding time of the switching signal 26 by the change rate detector 21 or the switching signal generator 23 is approximately 50 ms corresponding to the time “h” shown in FIG. 2D. When this switching signal 26 is provided to the analog switch 24, the analog switch 24 switches from the terminal SWa to the terminal SWb. Since the sample-and-hold circuit 25 stores the optical output voltage from the optical output monitor circuit 5 as the latest value, the optical signal output level at the time “a” when the optical input having started to fluctuate as shown in FIG. 2A is outputted as the electric signal. Therefore, although the optical output slightly falls below a stable level “j” as shown by a waveform portion “i” of FIG. 2D during the holding time “h” by the switching signal 26, substantially fixed optical output can be obtained. It is to be noted that a decrease of the optical output in this case assumes approximately the ¼ gain.

A waveform shown by a dotted line in FIG. 2A will now be described as an example of the high bit rate shown in FIG. 11A. It is to be noted that the threshold value of the voltage comparator 22 is set to Vth2 (Vth2<Vth1).

Firstly, when the optical input of the high bit rate shows a fluctuation or drop as shown by a dotted line waveform portion “d” which is smaller than that in the case of the low bit rate, the output waveform of the change rate detector 21 assumes a dotted line waveform “f” of FIG. 2B. This waveform “f” is compared with the threshold value Vth2 of the voltage comparator 22 for the high bit rate.

As a result, even if the waveform “f” does not reach the threshold value Vth1 for the low bit rate, since it reaches the lower threshold value Vth2, the waveforms “g” and “h” respectively in FIGS. 2C and 2D are the same as those in the case of the low bit rate. The optical output waveform shown in FIG. 2E resultantly assumes a dotted waveform portion “k”.

Although in this case the dotted waveform portion “k” of the high bit rate has a smaller fluctuation range compared with the solid line waveform portion “i” of the low bit rate, it is required to contain the fluctuation range within a fluctuation allowable range “l” since an allowable fluctuation range “l” of the high bit rate is inherently smaller than an allowable fluctuation range “m” of the low bit rate. In this case, since the waveform portion “k” is contained within the fluctuation allowable range “l”, the occurrence of the signal error can be prevented.

### Embodiment [2]

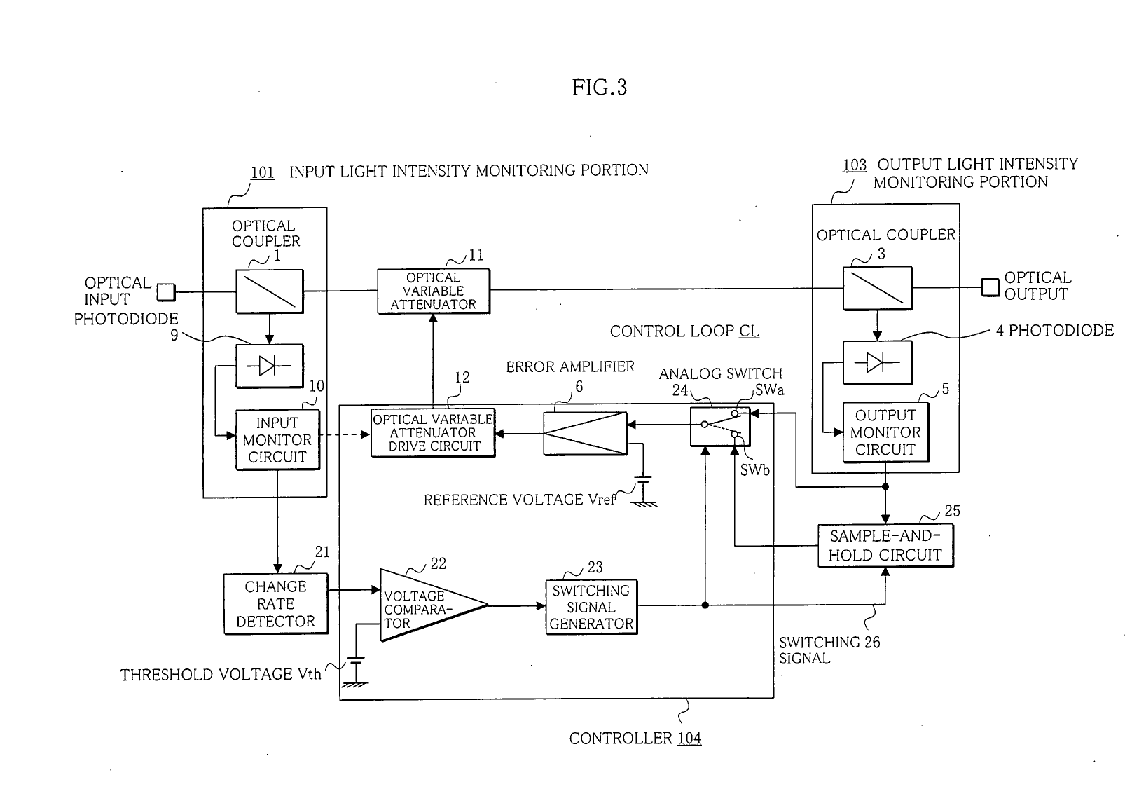

FIG. 3 shows an embodiment [2] of a light transmission apparatus according to the present invention. There are provided an input light intensity monitoring portion 101, a change rate detector 21 as a change rate monitoring portion, an optical variable attenuator 11 as an optical attenuator, an output light intensity monitoring portion 103, a sample-and-hold circuit 25 as a sampling portion, and a controller 104.

The input light intensity monitoring portion 101 is composed of an optical coupler 1, a photodiode 9, and an input monitor circuit 10. The controller 104 is composed of a voltage comparator 22, a switching signal generator 23, an analog switch 24, an error amplifier 6, and an optical variable attenuator drive circuit 12. The output light intensity monitoring portion 103 is composed of an optical coupler 3, a photodiode 4, and an output monitor circuit 5. The output monitor circuit 5 converts an electric signal (electric current) outputted from the photodiode 4 into the corresponding voltage.

The light transmission apparatus of the embodiment [2] is provided with a control loop CL which provides a feedback control for maintaining the optical output at a fixed value, as an excitation light controlling method. Hereinafter, elements composing the control loop CL will be described.

An input light is inputted to the optical variable attenuator 11 through the optical coupler 1. The optical variable attenuator 11 is controlled by the optical variable attenuator drive circuit 12 of the controller 104, and attenuates the input light to be outputted. A part of the output light from the optical variable attenuator 11 is branched by the optical coupler 3, monitored by the photodiode 4 and the output monitor circuit 5, and inputted to the controller 104. The controller 104 controls the optical variable attenuator drive circuit 12 based on the monitored optical output intensity of the optical variable attenuator 11, thereby performing the feedback control (optical output fixing control).

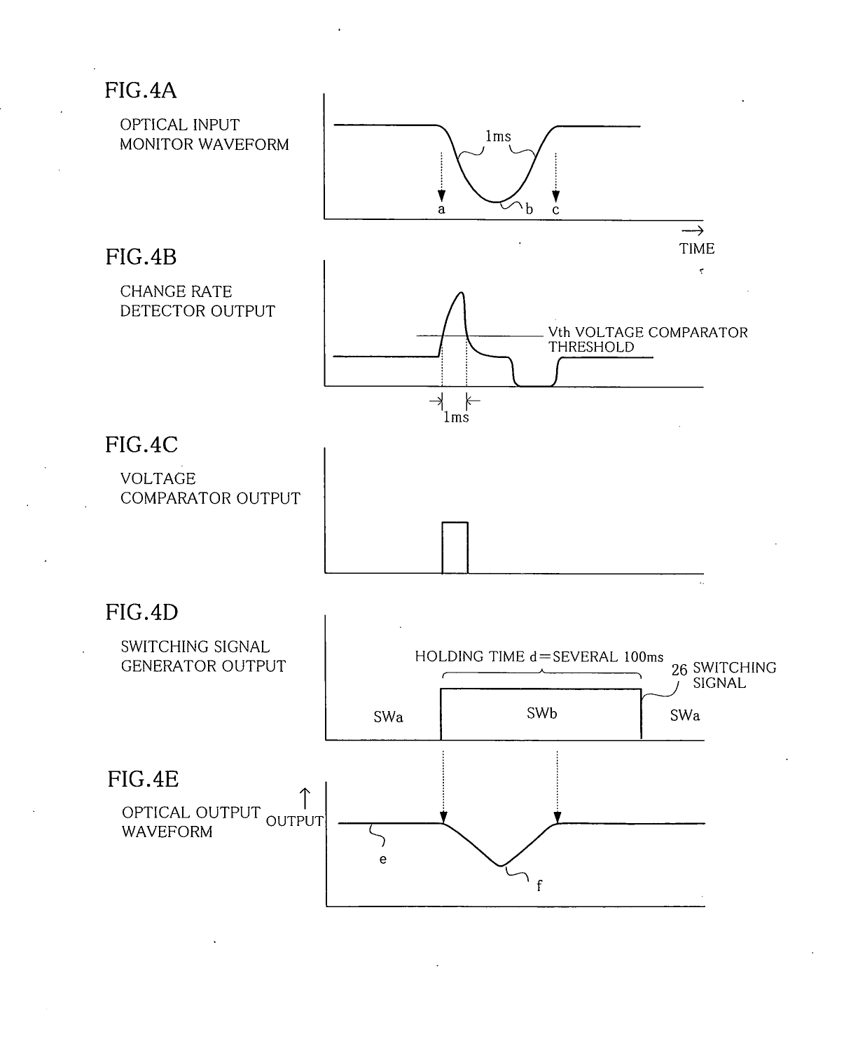

FIGS. 4A-4E show operational waveform diagrams of the embodiment [2], which are respectively similar to those shown in FIGS. 2A-2E. However, a holding time “d” of the switching signal 26 in FIG. 4D is several 100 ms, different from the example of FIG. 2D. As for the optical output waveform shown in FIG. 4E, the case of the embodiment [2] is basically the same as that of FIG. 2E except that a slightly decreased portion “f” based on the operation of the optical variable attenuator 11 is revealed.

Sample-and-Hold Circuit

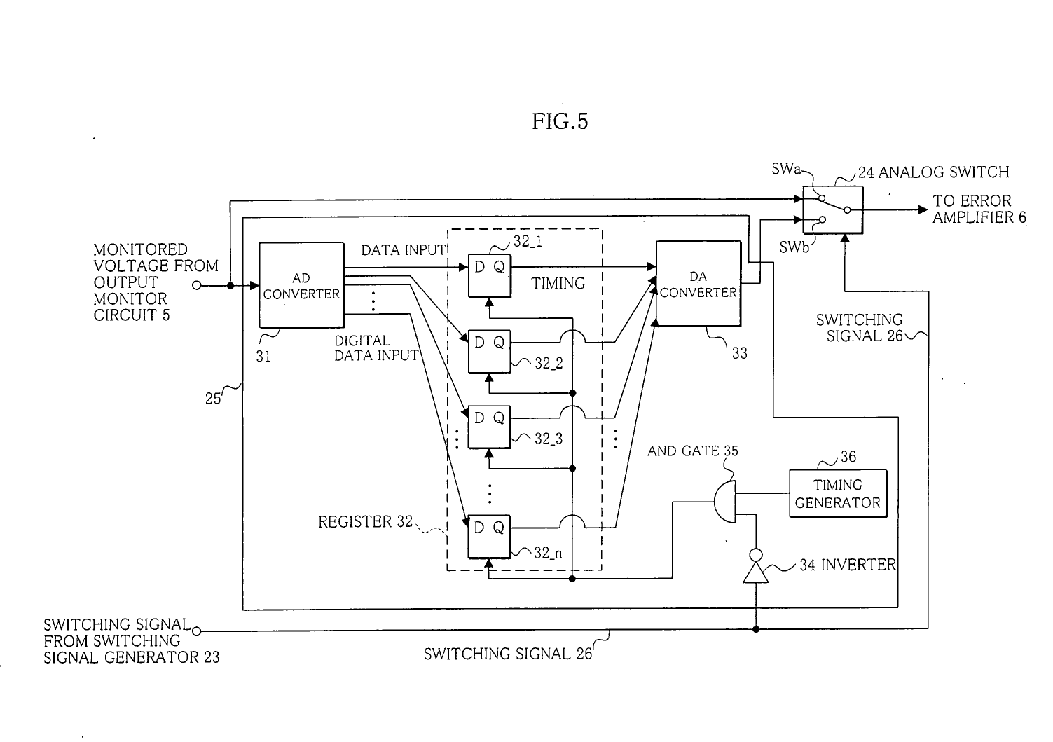

FIG. 5 shows an embodiment of a sample-and-hold circuit used in the above-mentioned embodiments [1] and [2]. In this embodiment, the monitored voltage from the output monitor circuit 5 is transmitted to an AD converter 31, converted into n-bit parallel digital signals, transmitted to a register 32, and provided to D-input terminals of “n” blocks of D-flip-flops 32_1-32_{—}n composing the register 32.

Parallel data signals from Q-output terminals of the D-flip-flops 32_1-32_{—}n are transmitted to a DA converter 33, converted therein into an analog signal, and transmitted to the terminal SWb of the analog switch 24. Also, the switching signal 26 from the switching signal generator 23 is transmitted to one input terminal of an AND gate 35 through an inverter 34. A timing pulse from a timing generator 36 is provided to the other input terminal of the AND gate 35. An output pulse of the AND gate 35 is provided to the D-flip-flops 32_1-32_{—}n in the register 32 as a latch signal.

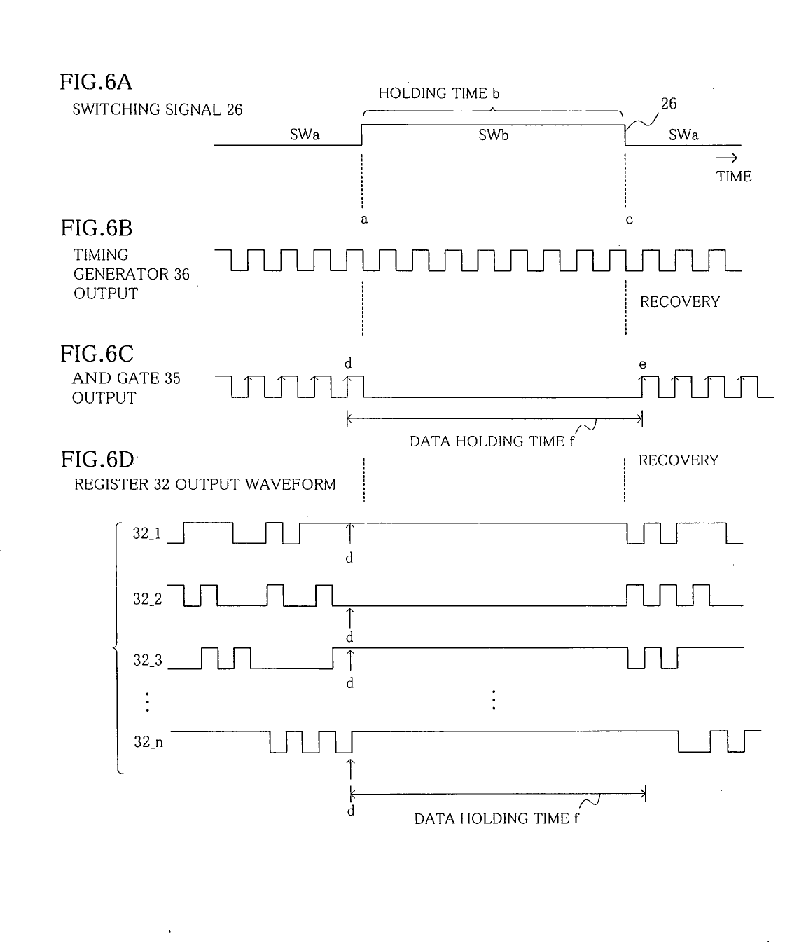

Operational time charts of such a sample-and-hold circuit 25 are shown in FIGS. 6A-6D. In these operational time charts, when the switching signal 26 shown in FIG. 6A is firstly provided to the sample-and-hold circuit 25, this signal is inverted by the inverter 34 in the sample-and-hold circuit 25 and transmitted to the AND gate 35. Also, the timing pulse shown in FIG. 6B is constantly provided to the AND gate 35 from the timing generator 36.

Therefore, the AND gate 35 does not provide the timing pulse to the register 32 during the holding time “b” by the switching signal 26 between times “a” and “c”. However, the register 32 has latched the parallel data from the AD converter 31 immediately before the fluctuation at a time “d” shown in FIG. 6C, which is held for a time “f” until a recovery time “e”.

Namely, as shown by output waveforms of the register 32 in FIG. 6D, since optical output data immediately before the time “d” are held and the analog switch 24 is switched to the side of the terminal SWb by the switching signal 26, and the DA converter 33 converts the data at the time “d” into an analog signal to be transmitted to the analog switch 24, thereby providing the error amplifier 6 with the data immediately before the optical input fluctuation.

It is to be noted in the above-mentioned embodiment that a monostable multivibrator may be used as the switching signal generator 23, and the holding time of the monostable multivibrator is approximately 50 ms in case of the above-mentioned embodiment [1] and several 100 ms in case of the above-mentioned embodiment [2]. Moreover, as alternatives for the sample-and-hold circuit 25, various circuits such as those using a memory and an up-down counter may be used.

While the optical output fixing control has been described in the above-mentioned embodiment, controls such as a gain fixing control using the monitored input light intensity are also possible.

Also, while in the above-mentioned embodiment, a sampling operation and a holding operation are performed by the sample-and-hold circuit, it is possible to perform only the sampling operation in the sampling portion and to perform the holding operation in the second control state within the controller.

1. A light transmission apparatus comprising:
an input light intensity monitoring portion which branches an input light and monitors an intensity of the input light;
a change rate monitoring portion which monitors a change rate of the input light intensity;
an excitation light source which outputs an excitation light;
an optical amplifier which amplifies the input light with the excitation light;
an output light intensity monitoring portion which branches an output light of the optical amplifier and monitors an intensity of the output light and a sampling portion which periodically monitors the output light intensity monitored by the output light intensity monitoring portion;
said apparatus having:
a first control state in which the output light intensity is controlled by controlling the excitation light source based on an output of the output light intensity monitoring portion; and
a second control state in which the excitation light source is controlled based on the output light intensity monitored by the sampling portion; and
said apparatus operating in the second control state when the change rate monitored by the change rate monitoring portion exceeds a threshold value, based on the output light intensity monitored by the sampling portion immediately before the threshold value is exceeded.

2. The light transmission apparatus as claimed in claim 1, further having a third control state in which the output of the excitation light source is suppressed when the input light intensity monitored by the input light intensity monitoring portion is equal to or less than a predetermined value.

3. The light transmission apparatus as claimed in claim 1 wherein the sampling portion comprises an AD converter converting the output light intensity monitored by the output light intensity monitoring portion into parallel data, a timing generator generating a timing signal, a register latching the parallel data by the timing signal, a DA converter converting the parallel data latched by the register into an analog signal to be provided to a switching circuit for the first and second control states, and a circuit canceling the timing signal in the second control state.

4. The light transmission apparatus as claimed in claim 1 wherein a transition is made from the second control state to the first control state after a lapse of time associated with a characteristic of the optical amplifier.

5. The light transmission apparatus as claimed in claim 1 wherein the threshold value is set to be associated with a characteristic of the optical amplifier and a bit rate of the input light.

6. A light transmission apparatus comprising:
an input light intensity monitoring portion which branches an input light and monitors an intensity of the input light;
a change rate monitoring portion which monitors a change rate of the input light intensity;
an optical attenuator which attenuates the input light;
an output light intensity monitoring portion which branches an output light of the optical attenuator and monitors an intensity of the output light; and
a sampling portion which periodically monitors the output light intensity monitored by the output light intensity monitoring portion;
said apparatus having:
a first control state in which the output light intensity is controlled by controlling the optical attenuator based on an output of the output light intensity monitoring portion; and
a second control state in which the optical attenuator is controlled based on the output light intensity monitored by the sampling portion; and
said apparatus operating in the second control state when the change rate monitored by the change rate monitoring portion exceeds a threshold value, based on the output light intensity monitored by the sampling portion immediately before the threshold value is exceeded.

7. The light transmission apparatus as claimed in claim 6 wherein the sampling portion comprises an AD converter converting the output light intensity monitored by the output light intensity monitoring portion into parallel data, a timing generator generating a timing signal, a register latching the parallel data by the timing signal, a DA converter converting the parallel data latched by the register into an analog signal to be provided to a switching circuit for the first and second control states, and a circuit canceling the timing signal in the second control state.

8. The light transmission apparatus as claimed in claim 6 wherein a transition is made from the second control state to the first control state after a lapse of time associated with a characteristic of the optical attenuator.

9. The light transmission apparatus as claimed in claim 6 wherein the threshold value is set to be associated with a characteristic of the optical attenuator and a bit rate of the input light.

10. A light transmission apparatus comprising:
a change rate monitoring portion which monitors a change rate of an input light intensity;
an excitation light source which outputs an excitation light for excitation an optical amplifier; and
a sampling portion which periodically monitors an output light intensity of the optical amplifier;
said apparatus having:
a first control state in which the output light intensity is controlled by controlling the excitation light source based on the output light intensity of the optical amplifier; and
a second control state in which the excitation light source is controlled based on the output light intensity monitored by the sampling portion; and
said apparatus operating in the second control state when the change rate monitored by the change rate monitoring portion exceeds a threshold value, based on the output light intensity monitored by the sampling portion immediately before the threshold value is exceeded.
